(19) United States
(12) Patent Application Publication
(10) Pub. No.: US 2007/0000915 A1
(43) Pub. Date: Jan. 4, 2007

(54) Laminated Cookware with a Protected Edge

(75) Inventor: STANLEY KIN SUI CHENG, VALLEJO, CA (US)

Correspondence Address: MEYER CORPORATION, U.S.;ATTN: EDWARD S. SHERMAN, ESQ., ONE MEYER PLAZA, VALLEJO, CA, 94590, US

(73) Assignee: MEYER INTELLECTUAL PROPERTIES LIMITED, Hong Kong (CN)

(21) Appl. No.: 11/460,350

(22) Filed: Jul. 27, 2006

Related U.S. Application Data
(63) Continuation-in-part of application No. 11/157,352, filed on Jun. 21, 2005.

(51) Int. Cl. H05B 6/12

(52) U.S. Cl. 219/621

(57) ABSTRACT

A multiple layer clad article of cookware has an upper rim wherein the inner and outer layers of the cladding, generally stainless steel, are joined together by a weld that covers and protects the one or more inner layers. The inner layers are alternatively at least one of copper and aluminum, or combinations of the same.

### CROSS REFERENCE TO RELATED APPLICATIONS

This application is a Continuation-In-Part application claiming priority to the U.S. Utility patent application for “Laminated Cookware”, filed on Jun. 21, 2005 and now having Ser. No. 11/157,352, which is incorporated herein by reference.

### BACKGROUND OF INVENTION

The present invention relates to an improved process for fabricating laminated cookware articles, and more specifically a process for forming improved multilayer clad cookware articles.

Laminated cookware articles are well known. They typically deploy copper and/or aluminum as one or more core layers, with surrounding layers to form the exposed interior and/or exterior surface of the cookware.

Among other benefits, the copper and/or aluminum core layers enhance the thermal performance of the cookware; enabling both a faster heating of the foodstuffs and a more uniform temperature distribution. Outer layers of the laminate, that surrounds the copper and/or aluminum core, can provide an exterior surface that is easier to clean or maintain in a particularly desired appearance in the kitchen.

Such laminated articles of cookware are fabricated starting with pre-laminated sheet stock. Methods of making sheet stock suitable for the eventual forming of cookware are disclosed in U.S. Pat. No. 6,427,904 to Groll, titled “Bonding of Dissimilar Metals”, and U.S. Pat. No. 6,109,504, also to Groll and titled “Copper Core Cooking Griddle and Method of Making Same”. The '504 Patent teaches the desirability of forming a sheet stock laminate of stainless steel/copper/stainless steel (which is the used to fabricate cookware) via the sequential reduction of thickness by repeated hot roll bonding steps. The preferred composition is a diffusion bonded composite of 304L grade stainless steel outer layers with an inner core of high purity C-102 grade copper. However, explosion bonding is initially used to laminate the three layers.

The cookware is then fabricated from the laminated sheet stock by first cutting or trimming the sheet stock into a round shape. The round trimmed pieces are then deformed or drawn in a die to form a fluid containing cookware vessel. However, as the laminating process itself is cumbersome, using expensive laminated stock material, this adds to the cost of the final product. Moreover, a large portion of this expensive material is lost as waste trim. This trim material, being laminated, it also difficult to recycle.

Further, the trimming process results in the exposure of laminated layers that are between the outer cladding layers at the rim of the cooking vessel. The rim is now especially susceptible to denting, as it comprises softer metals than the stainless steel that is used for the cladding. Further, any copper exposed at this rim is subject to oxidation and tarnishing. Any aluminum exposed at the rim can actually be chemically etched by harsh dishwasher detergents.

Accordingly, it would be desirable and is a first object of the invention to provide an alternative process for forming laminated cookware that does not require the use of pre-laminated sheet stock.

It is a further objective of the invention to provide a process that forms an improved laminated cookware article in which the inner cladding layer(s) are not exposed at the rim, but are protected from mechanical damage and chemical degradation.

### SUMMARY OF INVENTION

In the present invention, the first object of providing a laminated article of cookware with a protected edge is achieved by forming a vessel wherein the core layer or layers to be protected at the rim are recessed below the high of the inner and outer layer of the laminate. The inner and outer layers are then deformed or rolled to meet proximate the middle of the rim. The inner and outer layers that meet at this junction are then welded together to cover and protect the inner or core layers of the laminate.

The laminated structure having the inner and outer sidewalls extending beyond the inner or core layers can be constructed by several methods as is further described herein.

In such tri or multi-clad cookware one or more of the inner layer(s) is a softer metal than the typical stainless steel cladding that form the exterior layers and is thus be protected from physical damage at this welded rim.

Accordingly, if one or more of the interior layers were aluminum, it would not be exposed and subject to attack and slow etching by alkaline dishwasher detergent, with the outer layers that form the outer stainless steel upper rim providing protection. Avoiding exposure and potential damage to an aluminum layer at the rim helps maintain a neat and clean appearance, as slight etching of aluminum can leave a groove that would trap and retain dirt and debris. Further, if one or more of the inner layers is copper, tarnishing is avoided.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1A is a cross-sectional elevation of an article of cookware according to a first embodiment of the invention.

FIG. 1B is a partial view showing the rim of the cookware article of FIG. 1A in greater detail.

FIG. 2A-G is a schematic diagram illustrating the steps in the process used to fabricate an article of cookware comparable to that in FIG. 1.

FIG. 3A-G is a schematic diagram illustrating the steps in the process used to fabricate an article of cookware corresponding to another alternative embodiment of the invention.

FIG. 4A-D is a schematic diagram illustrating an alternative process used to fabricate articles of cookware that correspond to various embodiments of the invention.

FIG. 5A-D is a schematic diagram illustrating another alternative process used to fabricate articles of cookware that correspond to various embodiments of the invention.

It should be understood that the above figures are not drawn to scale, but rather to better illustrate the salient features of different embodiments of the invention. Hence, preferred dimensions are provided in the detailed description that follows.

### DETAILED DESCRIPTION

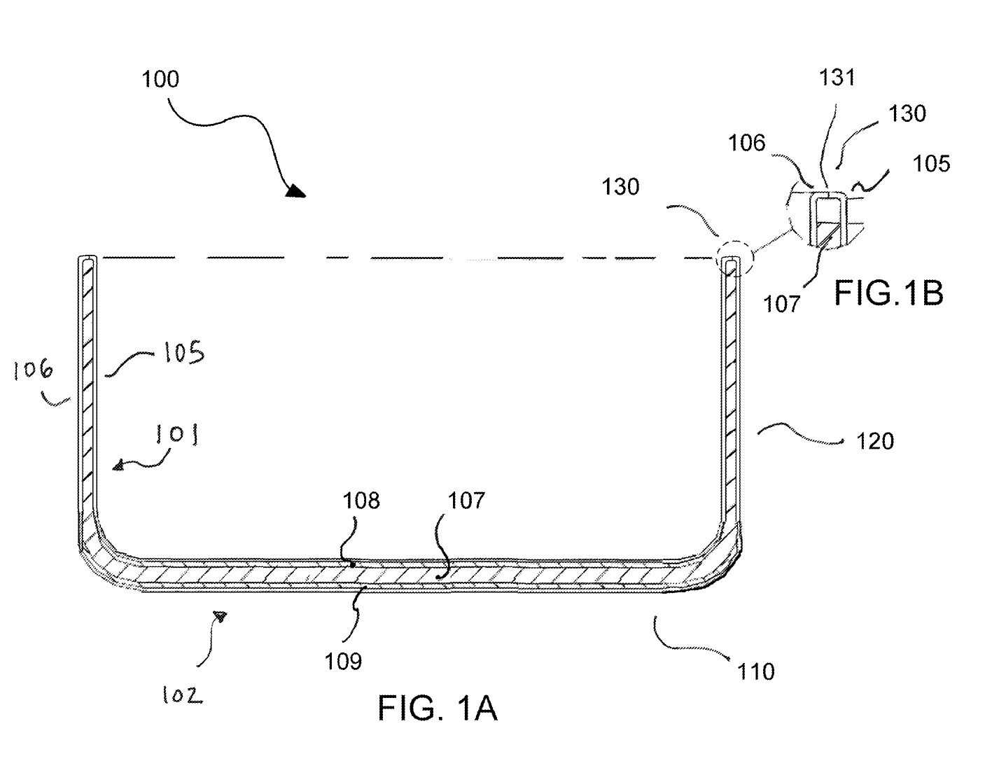

Referring to FIGS. 1 through 5, wherein like reference numerals refer to like components in the various views, there is illustrated therein a new and improved clad article of cookware, generally denominated 100 herein.

In accordance with the present invention, FIG. 1A illustrates a first embodiment of the invention in which an article of cookware 100 has a bottom cooking surface 110 surrounded by an upward extending sidewall 120 to form a fluid containing vessel. The upward extending sidewall 120 terminates at the rim 130 of the article of cookware 100.

The article of cookware 100 generally also includes one or more sideward extending handles, which are not shown in the drawing. The sidewall 120 and bottom 110 have a laminated construction in which the entire inner cooking surface 101 is preferably lined with a layer of stainless steel 105. The exterior of the cooking vessel 102 is also preferably lined with another layer stainless steel 106.

At least one layer of a core material 107 is surrounded by the inner and outer stainless steel layers 105 and 106. Additional layers that are preferably metallic may be laminated at the bottom of the cookware article, such as substantially planar thermally conductive metal plates 108 and 109, which increase the thickness of the bottom 110 with respect to the sidewall when the core material 107 has a consistent thickness at the bottom and sidewalls of the cookware article.

As shown in further detail in FIG. 1B, the inner and outer stainless steel layers 105 and 106 are joined at rim 130 to seal the core material 107.

Preferably, layer 107 is aluminum grade 1100 having a thickness of about 2 mm. Further, preferably substantially planar thermally conductive metal plates 108 and 109 are also aluminum grade 1100 having a thickness of about 2 mm.

As the inner and outer stainless steel layers 105 and 106 are preferably grade 430 stainless with a thickness of about 0.6 mm, the sidewalls 120 have a total thickness of about 3.2 mm, while the bottom 110 has a thickness of about 7.2 mm. It is more preferable in certain embodiments to use a magnetic grade of stainless steel, such as 430 grade, so the completed article of cookware can be used on an induction cooking range.

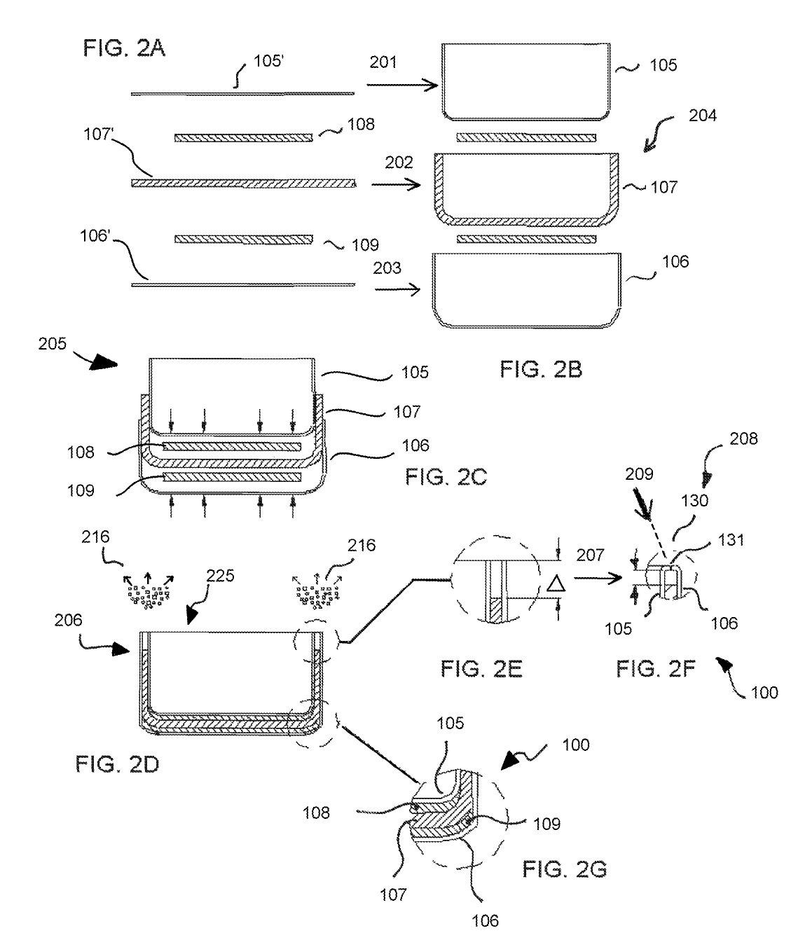

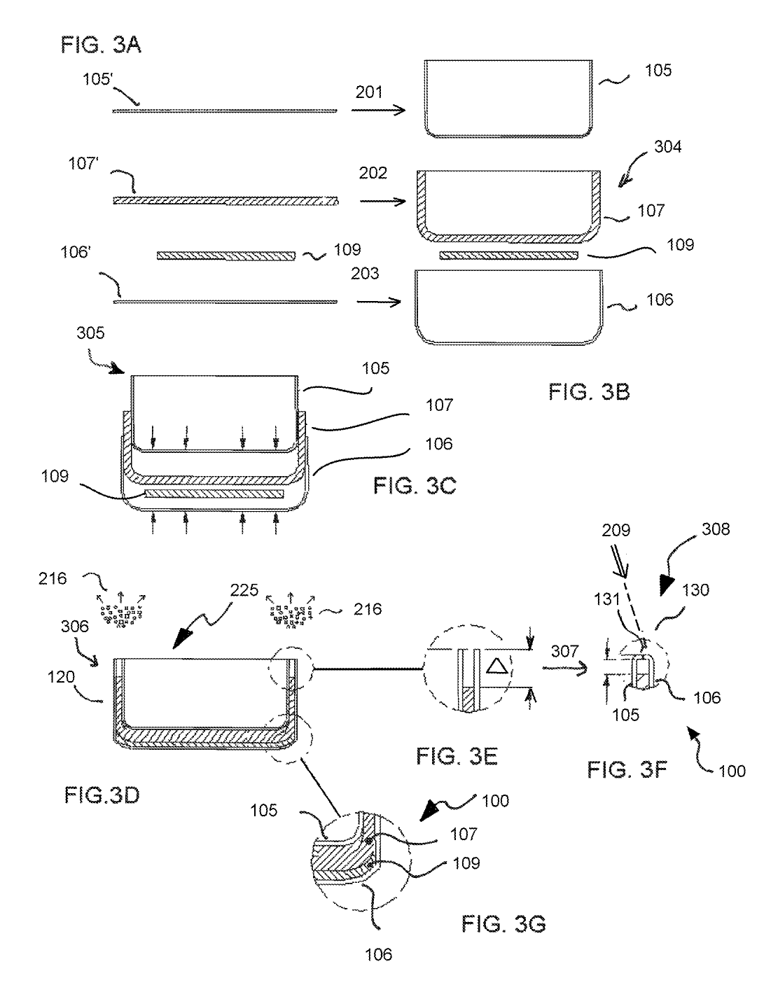

As shown in further detail in FIG. 1B, the inner and outer stainless steel layers 105 and 106 are joined at rim 130 to seal the core material 107. Preferably, the inner and outer stainless steel layers 105 and 106 are joined at rim 130 by welding, as will be more fully described with the other fabrication processes in FIGS. 2 and 3 that now follow. It should be appreciated that by sealing the core material 107 at rim 130, what would generally be at least one layer of softer copper or aluminum is now protected from denting and/or chemical and abrasive attack by the stainless layers outer layers

The ability to protect the inner cladding layer(s), such as 107 is unique to the various alternative processes of forming the laminated cookware article, as the inner and outer stainless steel layer 105 and 106 need to be higher to extend over the inner layer 107 such that they make proximate contact when rolled over to meet at the common seam or joint line 131.

Thus, FIGS. 2-5 illustrates alternative, but non-limiting, embodiments of the invention in which various sequences of steps are used to fabricate the precursor to article of cookware 100, shown in FIG. 2D, 3D, 4C and 5C. The process described with respect to FIG. 2 and FIG. 3 has two advantages. First, it provides a cost savings compared to forming a cooking vessel by deforming a sheet of clad metal comprising a uniform layer of stainless steel bonded to a uniform layer of aluminum or copper. Further, the process allows the inner and outer cladding layers to extend beyond the middle layer such that when rolled to form the rim 130 they will meet at a common seam or joint line 131.

Thus, starting with the first of these alternative processes, as shown in FIG. 2A as step 201, a substantially planar sheet of stainless 105′, is drawn to form a fluid liner or inner shell 105. In this embodiment, inner shell 105 will become the interior of the completed cooking vessel 100.

In step 202, also shown in FIG. 2A a substantially planar sheet of a thermally conductive material 107′, such as at least one of copper or aluminum, or any alloy or laminate is drawn to form a fluid containing core shell 107.

In step 203, also shown in FIG. 2A a substantially planar sheet of stainless steel 106′ is drawn to form a fluid containing outer shell 106. Preferably both planar sheets 105′ and 106′ are grade 304 stainless steel alloy. However, to the extent that it is desirable to utilize the completed article of cookware with induction cooking, stainless steel grade 430 is preferred for at least one of planar sheets 105′ and 106′, and more preferably for both.

In step 204, shown in FIG. 2B, the inner shell 105, core shell 107 and outer shell 106 are arrayed for nesting with additional layer of substantially planar thermally conductive metal 109 and 108 interposed between the bottom forming portion of each pair of shells to be nested. A brazing compound is applied to at least one of the shell components and/or planar sheets to be joined.

In step 205, to complete the brazing process, the temperature of the subassembly is raised to melt the brazing compound, which upon cooling forms a metallurgical bond at each interface between the shells. Pressure is applied to compress the shells against each other at their common interfaces, facilitating the consolidation and flow of the liquid brazing compound. It should be appreciated that each of the shells 105, 106 and 107 are drawn in steps 201, 202 and 203 respectively with sufficient dimension tolerances to facilitate complete insertion of each shell in the other. A slight gap is also provided to accommodate the solid brazing compound (as well as for the eventual wicking of the molten brazing compound or liquid flux) at each common interface.

Shown schematically in FIG. 2D is step 206, an “ironing process” to reduce the thickness of the sidewall 120. “Ironing” is done by the continued deep drawing of subassembly 225 in a set of dies in which the clearance between male and female die members is progressively smaller than the actual combined thicknesses of the sidewall 120. As shown in FIG. 2G, a partial view showing the detailed construction of the lower corner of cookware article 100, bottom 110 includes five laminated layers of shell 105/plate 108/shell 107/plate 109/shell 106. However, sidewall 120 is a lamination of three layers, which are shell 105/shell 107/shell 106.

In the various embodiment shown in at least FIG. 1-3, the inner shell 107 is preferably aluminum, copper or alloys thereof, which being much softer than stainless steel 105, will under go a reduction in thickness during the iron process of FIG. 2D. Further, as it can be difficult in the brazing process of step 205 to fully reflow the liquid flux over the entire interfacial area to be bonded, air and moisture can be trapped within this gap. The “ironing process” has another advantage in that it gradually expels air and moisture trapped at each common interface, which is shown schematically on each side of the vessel as reference number 216. As the stainless steel layers 105 and 106 are not drawn during the “ironing” step 204, it will remain the same height as when formed in steps 201 and 203. However, as the wall thickness of the core layer 107 is reduced, the height of this wall will increase from that resulted from forming step 202.

However, as shown in FIG. 2E it is important that the stainless steel rims of the inner and outer shells 105 and 106 extend beyond the upper most portion of the core shell 107 after brazing and ironing so that the protective rim 130 can be formed.

It is possible to initially form both the inner shell 105 and outer shell 106 to provide a predetermined difference in initial wall heights with respect to the core layer to facilitate their joining to form rim 130. However, it is preferable to trim the inner and outer layers 105 and 106 that form sidewall 120 to define the final rim height after the “ironing” process. This trimming step may utilize conventional mechanical cutting tools, water jet cutting, laser cutting and the like. The height difference, A, with respect to the core layer 107 is typically about 5 mm before trimming, and 2-3 mm after the rolling and welding together of these edges. Thus, after trimming, in step 207, the inner and outer layers are rolled to meet at common seam 131.

In the next step 208 in the process either inert gas welding or laser welding and the like is utilized to fully bond and thus tightly seal the inner shell 105 to the outer shells 106 at the intended rim position, shown in FIG. 2F. In step 209, a radiant energy source is focused to heat the intended rim area. The welding torch arc or laser beam is oriented to impinge on seam 131, which is indicated as 209.

Laser welding is well known in the art of metal fabrication. One of ordinary skill in this art can readily determine the optimum laser welding conditions appropriate to the thickness, absorption and heat capacity of the copper and stainless steel layers at the weld location by routine experimentation.

Alternatively, the bond or seam can be formed by inert gas welding, such as TIG or MIG welding.

After the bonding of rim seam 131, the article of cookware is preferably polished to achieve the desired aesthetic appearance. After the trimming and polishing steps in the fabrication process shown in FIG. 2A-2G, one or more handles are generally attached to sidewall 120.

Ironing is a preferred but not a limiting embodiment, depending on the ease and integrity of the bond formed in the initial brazing process.

FIG. 3 illustrates another alternative embodiment of the invention in which only a single plate 109 is inserted between shell 106 and 107. Shells 105, 106 and 107 are formed by drawing their respective precursor plates 105′, 106′ and 107′ as shown in process steps 201, 202 and 203 respectively. All three shells are comparably nested as shown in step 305, and brazed to incorporate plate 109. It should be appreciated that plate 109 could alternatively be inserted between shell 105 and 107. Thus, the cookware article of this alternative embodiment can be fabricated starting with step 201 of FIG. 3A in which a substantially planar sheet of stainless 105′, is drawn to form a fluid liner or inner shell 105. In this embodiment, inner shell 105 will become the interior of the completed cooking vessel 100.

In step 202, also shown in FIG. 3A a substantially planar sheet of a thermally conductive material 107′, such as at least one of copper or aluminum, or any alloy or laminate is drawn to form a fluid containing core shell 107.

In step 203, also shown in FIG. 3A a substantially planar sheet of stainless steel 106′ is drawn to form a fluid containing outer shell 106. Preferably both planar sheets 105′ and 106′ are grade 304 stainless steel alloy. However, to the extent that it is desirable to utilize the completed article of cookware with induction cooking, stainless steel grade 430 is preferred for at least one of planar sheets 105′ and 106′, and more preferably for both.

In step 304, shown in FIG. 3B, the inner shell 105, core shell 107 and outer shell 106 are arrayed for nesting with additional layer of substantially planar thermally conductive metal 109 interposed between bottom of both the core shell 107 and outer shell 106. A brazing compound is applied to at least one of the shell components and/or planar sheet to be joined.

In step 305 (FIG. 3C) to complete the brazing process, the temperature of the subassembly is raised to melt the brazing compound, which upon cooling forms a metallurgical bond at each interface between the shells. Pressure is applied to compress the shells against each other at their common interfaces, facilitating the consolidation and flow of the liquid brazing compound. It should be appreciated that each of the shells 105, 106 and 107 are drawn in steps 201, 202 and 203 respectively with sufficient dimension tolerances to facilitate complete insertion of each shell in the other. A slight gap is also provided to accommodate the solid brazing compound (as well as for the eventual wicking of the molten brazing compound or liquid flux) at each common interface.

Shown schematically in FIG. 3D is step 306, an “ironing process” to reduce the thickness of the sidewall 120. “Ironing” is done by the continued deep drawing of subassembly 225 in a set of dies in which the clearance between male and female die members is progressively smaller than the actual combined thicknesses of the sidewall 120. As shown in FIG. 2G, a partial view showing the detailed construction of the lower corner of cookware article 100, bottom 110 includes four laminated layers of shell 105/shell 107/plate 109/shell 106. However, sidewall 120 is a lamination of three layers, which are shell 105/shell 107/shell 106.

However, as shown in FIG. 3E it is important that the stainless steel rims of the inner and outer shells 105 and 106 extend beyond the upper most portion of the core shell 107 after brazing and ironing so that the protective rim 130 can be formed.

It is possible to initially form both the inner shell 105 and outer shell 106 to provide a predetermined difference in initial wall heights with respect to the core layer to facilitate their joining to form rim 130. However, it is preferable to trim the inner and outer layers 105 and 106 that form sidewall 120 to define the final rim height after the “ironing” process. This trimming step may utilize conventional mechanical cutting tools, water jet cutting, laser cutting and the like. The height difference, A, with respect to the core layer 107 is typically about 5 mm before trimming, and 2-3 mm after the rolling and welding together of these edges. Thus, after trimming, in step 207, the inner and outer layers are rolled to meet at common seam 131.

In the next step 308 in the process either inert gas welding or laser welding and the like is utilized to fully bond and thus tightly seal the inner shell 105 to the outer shells 106 at the intended rim position, shown in FIG. 3F. In step 209, a radiant energy source is focused to heat the intended rim area. The welding torch arc or laser beam is oriented to impinge on seam 131, which is indicated as 209.

After the bonding of rim seam 131, the article of cookware is preferably polished to achieve the desired aesthetic appearance. After the trimming and polishing steps in the fabrication process shown in FIG. 3A-3G, one or more handles are generally attached to sidewall 120.

Further, the fabrication processes used to form cookware article 100 of FIG. 1, as illustrated in FIG. 2-3, has a lower manufacturing cost savings than constructing a comparable article of cookware starting from a triple ply clad sheet that comprise a stainless steel/copper (and/or aluminum)/stainless steel construction.

It should be appreciated that a multilayer laminated sheet of metal may be used to form one or more of the preforms that are nested inside each other and then bonded together in FIGS. 2 and 3. This may be desired when a particular pair of metal is more difficult to join by the inventive process, but a third metal is readily bonded by the inventive process after the corresponding preforms are nested together.

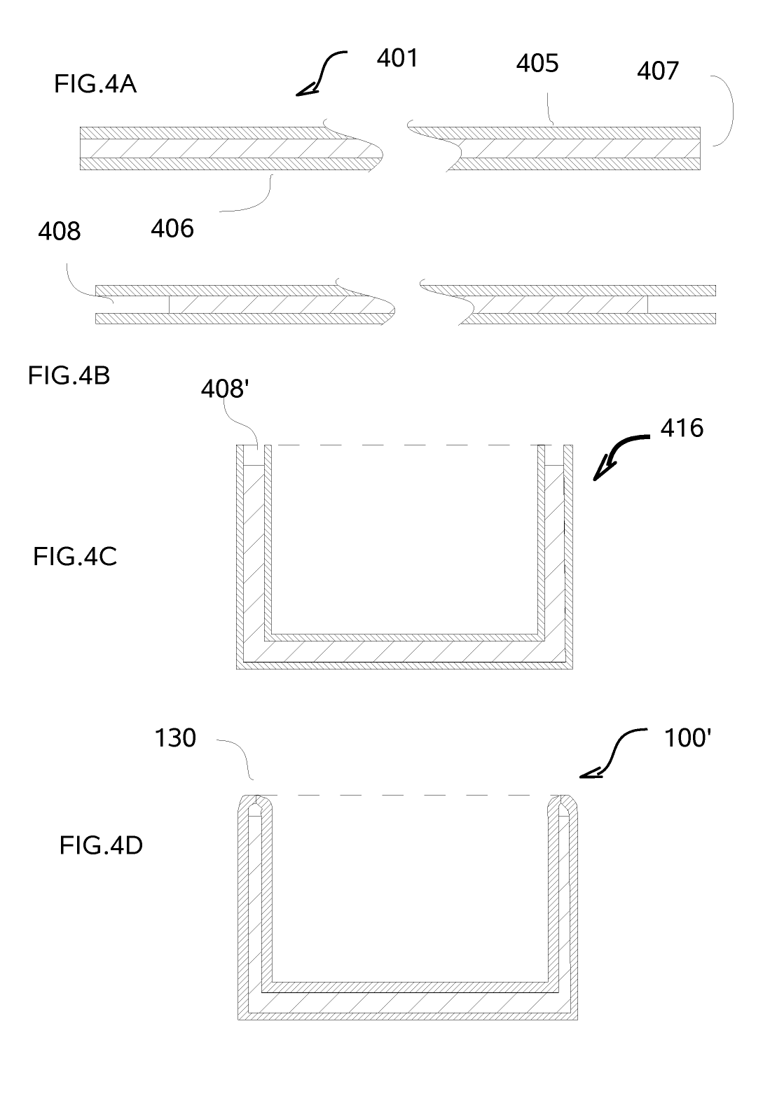

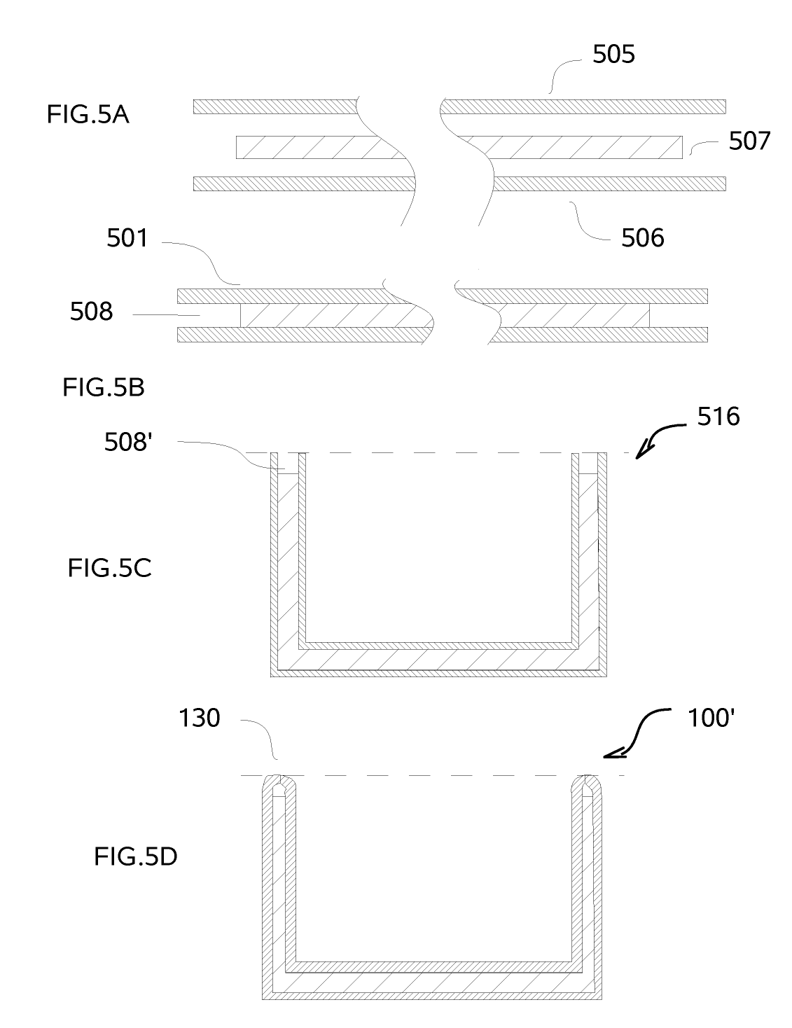

It should be appreciated that any of the core and shell members described herein can be formed by deep drawing a laminated structure provided a portion of the core layers at the rim are removed so that the rim of the inner and outer shells can be joined at a seam, thus protecting the core layers. Such alternative embodiments are shown in FIG. 4 and FIG. 5.

In FIG. 4A a laminated metal is first provided in the form circular plate 401 having a layered construction of stainless steel 405/copper and/or aluminum 407/stainless steel 406. As shown in FIG. 4B, a portion 408 of the core 407 has been removed at the periphery of circular plates 401. Thereafter the plate in FIG. 4B is deep drawn to form the fluid containing vessel 416 shown in FIG. 4C. It should be noted that now the region of the core removed in the previous step is disposed at the rim of the cookware article 408′. Thus, the process of folding over the inner and outer layers of the laminate and welding them to form rim 130 (as previous described with respect to FIGS. 2E and 2F) can now be carried out to form vessel 100′ shown in FIG. 4D.

Alternatively, as shown in FIG. 5, preform 501 (in FIG. 5B) is ready to be deep drawn to form vessel 516 (in FIG. 4C). Preform 501 can be formed of or by the laminating and at least partial attachment of circular plates 505, 507 and 506 together. It should be noted that the inner plates 507, which is typically at least one of aluminum and copper, has a smaller diameter that the other plates, by typically 4 to 10 mm, so that after lamination as flat plates a peripheral edge gap 508 is present at the core. Thereafter this perform 501 in FIG. 5B is deep drawn to form the fluid containing vessel 516 shown in FIG. 5C. It should be noted that now the region of core removed is disposed at the rim of the cookware article 508′. Thus, the process of folding over the inner and outer layers of the laminate and welding them to form rim 130 (as previous described with respect to FIGS. 2E and 2F) can now be carried out to form vessel 100′ shown in FIG. 5D.

It should be appreciated that alternatives to the embodiments described with respect to FIGS. 2 and 5 include substituting aluminum for copper or a lamination of copper and aluminum layers. Further embodiments include a construction wherein titanium, including alloys thereof, and aluminum or aluminum alloy preforms are bonded to each other. In such instances it would be preferable if the titanium or titanium alloy preform was used as the inner shell, with the aluminum or aluminum alloy preform as the outer shell. Such a bonded preform can be anodized by conventional processes after the bonding steps, thereby rendering the outer aluminum shell into the harder anodized aluminum, while providing a more chemically resistant titanium metal as the inner cooking surface.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. An article of cookware comprising:
a) a bottom surface,
b) surrounding sides extending upward there from to form a fluid containing vessel,
c) wherein the interior of the vessel has a lining and the exterior vessel has an outer cladding that are welded together at the rim to encapsulate a thermally conductive material a thermally conductive material that substantially fills the region between the lining and cladding.

2. An article of cookware according to claim 1 wherein the thermally conductive material is thicker at said bottom surface.

3. An article of cookware according to claim 1 wherein the thermally conductive material at said bottom surface comprises two or more layers.

4. An article of cookware according to claim 2 wherein the thermally conductive material at said bottom surface comprises two or more layers.

5. An article of cookware according to claim 2 wherein the thermally conductive material at said bottom surface comprises at least one layer that comprises copper layer and another layer of aluminum.

6. An article of cookware according to claim 2 wherein the thermally conductive material at said bottom surface comprises at least three layers and the thermally conductive material in said surrounding sides comprises at least one layer.

7. An article of cookware according to claim 1 wherein at least one of the interior lining and outer cladding is selected from the group consisting of stainless steel and titanium or an alloy thereof.

8. An article of cookware according to claim 1 wherein the lining and outer cladding are stainless steel and the thermally conductive material comprises at least one layer of aluminum or an alloy thereof.

9. An article of cookware according to claim 8 wherein the thermally conductive material at the bottom comprises at least one layer of aluminum between two or more additional layers of thermally conductive material.

10. A method of fabricating an article of cookware, the method comprising:
a) providing a first perform having;
i) a bottom surface, and
ii) surrounding sides extending upward there from to form a fluid containing vessel, wherein
(1) the interior of the vessel has a lining and the exterior of the vessel has a outer cladding that each terminate at a rim having a first height, and
(2) a thermally conductive material fills the region between the lining and cladding rising in the surrounding sides to a second height, wherein the first height exceeds the second height by at least about half the thickness of the thermally conductive material there between,
b) rolling the rim of the lining and the cladding to meet above the second height at a junction,
c) bonding the rim of the lining and the cladding at the junction.

11. The method of claim 10 wherein said step of bonding the rim is done by at least one of laser welding and inert gas welding.

12. The method of claim 10 wherein the first preform is fabricated by nesting a series of two or more fluid containing vessel shaped preforms and bonding said nested preforms.

13. The method of claim 10 wherein the first preform is fabricated by nesting a series of three or more fluid containing vessel shaped preforms and bonding said nested preforms.

14. A method of fabricating a clad multi-layer article of cookware, the method comprising:
a) providing a first substantially planar sheet comprising at least one layer of a first metal,
b) providing a second substantially planar sheet comprising at least one layer of a second metal,
c) drawing the first planar sheet to form a first preform that is a fluid containing vessel having a first rim,
d) drawing the second planar sheet to form a second preform that is a fluid containing vessel having a second rim that nests within the first preform, each fluid containing vessel having a bottom surface and surrounding sidewalls extending upward there from,
e) nesting the second perform within the first perform to form a subassembly,
f) wherein said step of nesting further comprises providing at least one continuous layer of a thermally conductive material between the first and second preform that extends in the sidewall thereof to a second height, whereby the first height exceeds the second height,
g) rolling the rim of the first and second preform toward to meet above the second height at a junction,
h) rolling the rim of the first and second preform at the junction.

15. The method of claim 14 further comprising the step of bonding the first and second preform to the thermally conductive material.

16. The method of claim 15 wherein said step of bonding comprises brazing.

17. The method of claim 16 wherein said step of bonding further comprises ironing after brazing.

18. The method of claim 16 further comprising the step of providing one or more plates of a thermally conductive material between the bottoms of the first and second preform prior to said step of bonding whereby the resulting vessel has a bottom cooking surface that is thicker than the sidewalls of the cooking vessel.

19. The method of claim 17 wherein the first and second preforms are stainless steel.

20. The method of claim 14 wherein at least one the first and second substantially planar sheets is a laminate of the thermally conductive material with the material that forms the inner or the outer surface of the completed clad cookware article.
